(19) United States
(12) Patent Application Publication
(10) Pub. No.: US 2003/0225240 A1
(43) Pub. Date: Dec. 4, 2003

(54) Modified urethane compositions containing adducts of O-phthalic anhydride ester polyols

(76) Inventor: Robert J. Quint, Watertown, CT (US)

Correspondence Address: Crompton Corporation, Benson Road, Middlebury, CT, 06749, US

(21) Appl. No.: 10/437,919

(22) Filed: May 15, 2003

Related U.S. Application Data
(63) Continuation-in-part of application No. 09/614,967, filed on Jul. 12, 2000, now abandoned.

(51) Int. Cl. C08G 18/10; C08G 18/30; C08G 18/32

(52) U.S. Cl. 528/60; 528/61

(57) ABSTRACT

A polyurethane elastomer is disclosed that comprises:

the acellular reaction product of a prepolymer comprising:

the reaction product of:

1) an aromatic ester polyol having the structure:

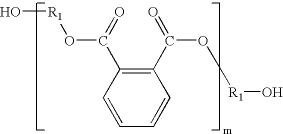

wherein:

R₁ is a divalent radical selected from the group consisting of:

(a) alkylene radicals of from 2 to 6 carbon atoms, and

(b) radicals of the formula:

—(R₂O)ₙ—R₂—

wherein R₂ is an alkylene radical of 2 or 3 carbon atoms, n is an integer of from 1 to 3, and m is an integer of from 1 to 15; and

2) a diisocyanate;

with a chain extender selected from the group consisting of water, aliphatic diols, aromatic diamines, and mixtures thereof.

### CROSS-REFERENCE TO RELATED APPLICATION

This is a continuation-in-part of co-pending U.S. patent application Ser. No. 09/614,967, filed Jul. 12, 2000.

### BACKGROUND OF THE INVENTION

1. Field of the Invention

The present invention relates to urethane compositions comprising polyester polyols based upon esters of phthalic anhydride. In particular, this invention relates to urethane compositions having reduced thermoplasticity, significantly increased tear strength, significantly higher flex fatigue resistance, and higher tensile strength and percent elongation as compared to similar compositions that do not contain the polyester polyols.

2. Description of Related Art

Polyurethane elastomers are well known; see, e.g., U.S. Pat. Nos. 4,294,951; 4,555,562; and 5,599,874. Polyurethane elastomers can be formed by reacting a diisocyanate, e.g., diphenyl methane diisocyanate (MDI), toluene diisocyanate (TDI), isophorone diisocyanate (IPDI), and the like., with an organic polyol, e.g., polytetramethylene ether glycol (PTMEG), polyester or polycaprolactone glycol (PE), homopolymers and copolymers of ethylene oxide and propylene oxide (E/PO), and the like, and a chain extender, e.g., an aliphatic diol, such as, 1,4 butanediol (BD), or an aromatic diamine, such as, diethyltoluene diamine (DETDA). Catalysts, such as, triethylene diamine (TEDA), can be used to increase the reactivity of the components. Additional components, such as, UV stabilizers, antioxidants, dyes, antistatic agents, and the like, can be added, if desired.

Industrial polyurethane elastomers are most commonly based on either MDI or toluene diisocyanate (TDI) prepolymers. Polyurethane prepolymers for elastomers are normally made by reacting polyols with excess molar amounts of diisocyanate monomers. While the two most commonly used aromatic diisocyanates are TDI and MDI, other aromatic diisocyanates, such as naphthalene diisocyanate (NDI), 3,3′-dimethyl-4,4′-biphenyl diisocyanate (TODI), and para-phenylene diisocyanate (PPDI) can also result in high-performance polymers, but at a higher cost than materials based on TDI or MDI. Aliphatic diisocyanates are all significantly more costly than TDI and MDI.

TDI-based solid polyurethane elastomers are most commonly made by reacting the liquid prepolymers with aromatic diamines, especially 4,4′-methylene-bis(3-chloroaniline) (MBCA) to give satisfactory properties. Diol curatives give generally inferior properties with TDI prepolymer. MBCA is suspected of being a carcinogen and thus requires careful attention to industrial hygiene during casting. It is unacceptable for biomedical and food industry applications.

U.S. Pat. No. 4,521,611 discloses a complex mixture of polyester polyols prepared by esterifying phthalic anhydride bottoms with aliphatic polyols. This mixture can be reacted with organic isocyanates in the presence of fluorocarbon blowing agent and preferably catalysts to produce cellular polymeric structures.

U.S. Pat. No. 4,526,908 discloses homogeneous liquid polyol blend compositions containing (a) certain aliphatic polyols, (b) phthalate diester polyols of said aliphatic polyols, and (c) trimellitate polyols of said aliphatic polyols. Such polyol blends are said to be useful in making homogeneous liquid resin prepolymer blend compositions containing, in addition to such a polyol blend, fluorocarbon blowing agent, cell stabilizing surfactant, and urethane and/or isocyanurate catalyst. Such a resin prepolymer blend composition is also disclosed to be suitable for reaction with organic isocyanates to produce cellular polyurethane and/or polyisocyanurate polymers.

U.S. Pat. No. 4,529,744 discloses compatibility agents and polyol blend compositions containing nonionic block ethoxylate propoxylate compounds, amine and amide diol compounds, and aromatic ester polyols, especially phthalate polyester polyols, which blends are miscible with fluorocarbon blowing agents. These blends are said to be suitable for reaction with polyfunctional organic isocyanates in the presence of trimerization catalyst to make cellular polyisocyanurates.

U.S. Pat. No. 4,595,711 discloses polyol blend compositions containing nonionic ethoxylate propoxylate compounds and aromatic ester polyols, especially phthalate polyester polyols, which blends are miscible with fluorocarbon blowing agents. These blends are said to be suitable for reaction with polyfunctional organic isocyanates in the presence of polymerization catalysts to make cellular polyurethanes and polyisocyanurates.

U.S. Pat. No. 4,608,432 discloses that terephthalate polyester polyol blends comprising reaction products of a combination of polyethylene terephthalate, a polybasic carboxylic acid compound, a low molecular weight diol compound and a compatibilizer compound are compatible with fluorocarbon blowing agents. These polyol blends are produced by a simple heating process and are thereafter blendable with various conventional polyols and other additives to make resin prepolymer blends which can be catalytically reacted with organic isocyanates to produce cellular polyurethanes and polyurethane/polyisocyanurates.

U.S. Pat. No. 4,615,822 discloses a resin prepolymer blend of (a) polyester polyols prepared by esterifying phthalic anhydride bottoms with aliphatic polyols; (b) aliphatic polyol, (c) compatibilizing polyalkoxylated compound, and (d) (optionally) polyalkoxylated amine or amide diol. This blend can be reacted with organic isocyanates in the presence of fluorocarbon blowing agent and preferably catalysts to produce cellular polymeric structures.

U.S. Pat. No. 4,644,027 discloses phthalate polyester polyols comprising reaction products of a phthalic acid compound, a low molecular weight diol compound and a hydrophobic compound that are compatibilized with fluorocarbon blowing agents. The polyols are producible by a simple heating process and are blendable with various conventional polyols and other additives to make resin prepolymer blends that can be catalytically reacted with organic isocyanates to produce cellular polyurethanes and polyurethane/polyisocyanurates.

U.S. Pat. No. 4,644,047 discloses phthalate polyester polyols comprising reaction products of a phthalic acid compound, a low molecular weight diol compound and a nonionic surfactant compound that are compatibilized with fluorocarbon blowing agents. The polyols are producible by a simple heating process and are blendable with various conventional polyols and other additives to make resin prepolymer blends that can be catalytically reacted with organic isocyanates to produce cellular polyurethanes and polyurethane/polyisocyanurates.

U.S. Pat. No. 4,644,048 discloses phthalate polyester polyols comprising reaction products of a phthalic acid compound, a low molecular weight diol compound and a hydrophobic compound and a nonionic surfactant compound that are compatible with fluorocarbon blowing agents. The polyols are producible by a simple heating process and are blendable with various conventional polyols and other additives to make resin prepolymer blends that can be catalytically reacted with organic isocyanates to produce cellular polyurethanes and polyurethane/polyisocyanurates.

U.S. Pat. No. 4,722,803 discloses fluorocarbon blowing agent compatible polyol blends comprising reaction products of a combination of (a) a residue from the manufacture of dimethyl terephthalate, (b) a low molecular weight diol compound, (c) a nonionic surfactant compound, (d) optionally a hydrophobic compound, and (e) optionally a polybasic carboxylic acid compound. These polyol blends are produced by a simple heating process and are thereafter optionally blendable with various conventional polyols and other additives (including fluorocarbons and catalysts) to make resin prepolymer blends. Such resin blends can be catalytically reacted with organic isocyanates to produce cellular polyurethanes and polyurethane/polyisocyanurates.

U.S. Pat. No. 5,077,371 discloses a low-free toluene diisocyanate prepolymer formed by reaction of a blend of the dimer of 2,4-toluene diisocyanate and an organic diisocyanate, preferably isomers of toluene diisocyanate, with high molecular weight polyols and optional low molecular weight polyols. The prepolymer can be further reacted with conventional organic diamines or organic polyol curatives to form elastomeric polyurethane/ureas or polyurethanes.

U.S. Pat. No. 5,654,390 discloses a trimodal molecular weight toluene diisocyanate endcapped polyether polyol prepolymer having free toluene diisocyanate below 0.5 weight percent where the three molecular weight polyols used are 300-800, 800-1500 and 1500-10000. Processes to make and use these prepolymers as polyurethane castable elastomers having exceptionally long flex fatigue lives using environmentally friendly materials essentially free of TDI are also disclosed.

U.S. Pat. No. 5,907,014 discloses an aromatic diisocyanate prepolymer combined with a dibasic ester, preferably a mixed dialkyl ester of adipic, glutaric and succinic acids, which when used with amine or polyol curatives to make solid, non-foamed elastomeric polyurethane and/or polyurethane/urea products reduces viscosity and improves wettability of the castable polyurethane prepolymer without loss of cured physical properties. This improved wettability of the liquid prepolymer is useful for impregnation of fabrics, preferably polyesters, during the manufacture of a polyurethane coated fabric type belting.

### SUMMARY OF THE INVENTION

It has now been found that the incorporation of certain glycol phthalic anhydride based polyester polyols in a urethane prepolymer provides unexpected enhancement of several properties. According to a commercial supplier, Stepan Company, such urethanes exhibit low viscosity, excellent hydrolysis resistance, hardness/flexibility balance, clarity and adhesion promotion. It has been found, unexpectedly, in a comparison of compositions with and without this type of polyol cured by the same curative to the same Shore A hardness that other properties are enhanced by incorporation of even a very low level of this type of polyol. These are reduced thermoplasticity, significantly increased tear strength both when measured at ambient temperature and at elevated temperature (70° C.), significantly higher flex fatigue resistance and higher tensile strength and % elongation at the same hardness. These enhancements can be realized with very little sacrifice of good dynamic properties, which can be very useful in the application of urethanes.

More particularly, the present invention is directed to a polyurethane elastomer comprising:

the acellular reaction product of a prepolymer comprising:

the reaction product of:

1) an aromatic ester polyol having the structure:

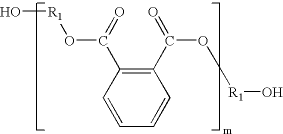

wherein:

R₁ is a divalent radical selected from the group consisting of:

(a) alkylene radicals of from 2 to 6 carbon atoms, and

(b) radicals of the formula:

—(R₂O)ₙ—R₂—

wherein R₂ is an alkylene radical of 2 or 3 carbon atoms, n is an integer of from 1 to 3, and m is an integer of from 1 to 15; and

2) a diisocyanate;

with a chain extender selected from the group consisting of water, aliphatic diols, aromatic diamines, and mixtures thereof.

In a preferred embodiment, the present invention is directed to a polyurethane elastomer comprising:

the acellular reaction product of a prepolymer comprising:

the reaction product of:

1) an aromatic ester polyol having the structure:

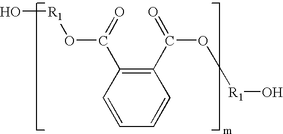

wherein:

R₁ is a divalent radical selected from the group consisting of:

(a) alkylene radicals of from 2 to 6 carbon atoms, and

(b) radicals of the formula:

—(R₂O)ₙ—R₂—

wherein R₂ is an alkylene radical of 2 or 3 carbon atoms, n is an integer of from 1 to 3, and m is an integer of from 1 to 15; and

2) a second hydroxyl-containing polyol different from said first hydroxyl-containing ester polyol; with

3) at least one diisocyanate;

with a chain extender selected from the group consisting of water, aliphatic diols, aromatic diamines, and mixtures thereof.

In more preferred embodiments of the above, the polyurethane elastomer has a flex fatigue resistance of at least about 32,000 cycles to failure. This number is generated by the Texus Flex instrument via ASTM Method No. D3629-78. The parameters used are as follows:

Temperature—70° C.

Direction—Reverse

30 and 45° Angle of Deflection

30 and 45% Strain.

### DESCRIPTION OF THE PREFERRED EMBODIMENT(S)

In the practice of the present invention, aromatic ester polyols are reacted with isocyanates to produce acellular polyurethane elastomers.

The aromatic polyester polyols are esters produced by esterifying phthalic acid or phthalic acid anhydride with an aliphatic polyhydric alcohol. For example, a diethylene glycol phthalate is available commercially from Stepan Company, Northfield, Ill. Such liquid product has a desirably low viscosity, a desirably high aromatic ring content, and a desirably low acid number.

These aromatic ester polyols are characterized by the formula:

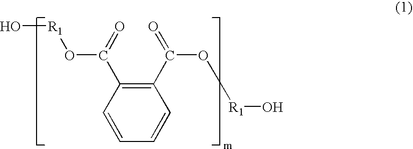

wherein:

R₁ is a divalent radical selected from the group consisting of:

(a) alkylene radicals of from 2 to 6 carbon atoms, and

(b) radicals of the formula:

—(R₂O)ₙ—R₂—

wherein R₂ is an alkylene radical of 2 or 3 carbon atoms, n is an integer of from 1 to 3, and m is an integer of from 1 to 15.

Compounds of formula (1) can be prepared by any convenient procedure as those skilled in the art will appreciate. By one preferred procedure, phthalic acid anhydride is contacted with a polyol of the formula:

HO—R₁—OH (2)

wherein: R₁ is a divalent radical identical to the definition of R₁ above in the definition of formula (1).

Examples of suitable glycol starting materials of formula (2) include ethylene glycol, diethylene glycol, propylene glycol, dipropylene glycol, trimethylene glycol, butylene glycols, 1,6-hexanediol, and any combination thereof, and the like. The most preferred starting polyols for reaction with a phthalic anhydride starting material are diethylene glycol and 1,6-hexanediol.

Preferably, the reaction between phthalic anhydride and a starting polyol of formula (2) above is carried out at a temperature ranging from about 200° to about 230° C., though lower and higher temperatures can be employed, if desired. During the reaction, the reactants are preferably agitated. Preferably, approximately stoichiometric amounts of phthalic anhydride and polyol are employed. Preferably, the reaction is continued until the hydroxyl value of the reaction mass falls in the range from about 6 to 224, and also the acid value of the reaction mass ranges from about 0.5 to 7.

The esterification reaction used for producing an aromatic polyol of formula (1) may, if desired, be carried out in the presence of a catalyst, as those skilled in the art will appreciate. Suitable catalysts include organotin compounds, particularly tin compounds of carboxylic acids, such as stannous octoate, stannous oleate, stannous acetate, stannous laurate, dibutyl tin dilaurate, and other such tin salts. Other suitable catalysts include metal catalysts, such as sodium and potassium acetate, tetraisopropyl titanates, and other such titanate salts, and the like.

These polyols preferably have a number average molecular weight in the range of from about 250 to about 10,000, more preferably in the range of from about 300 to about 3000, and most preferably in the range of from about 400 to about 2500.

An example of the preparation of a diethylene glycol phthalate is given in U.S. Pat. No. 4,644,047:

To a 3 liter, four-neck, round-bottom flask equipped with a stirrer, thermometer, nitrogen inlet tube, and a distilling head consisting of a straight adaptor with a sealed-on Liebig condenser, there is added 740 grams (5 moles) of phthalic anhydride, and 1060 grams (10 moles) of diethylene glycol. The mixture is heated to 220° C. with stirring and kept at this temperature until the rate of water being removed slowed down.

Stannous octoate (100 ppm) is then added to the mixture and the heating continued until the acid number reaches 6.2. The reaction mixture is then cooled to room temperature and analyzed. The hydroxyl number is found to be 288 and the acid number 6.2. Diethylene glycol is added to the mixture to increase the hydroxyl number to 315.

The product includes diethylene glycol phthalate molecules. This product is a colorless liquid which has a hydroxyl number of about 315 and has a viscosity of about 2500 centipoises at 25° C. measured with a Brookfield viscometer operating at 3 rpm with a #3 spindle and an hydroxyl number of about 315.

In combination with the aromatic ester polyol of formula (1), one can employ one or more additional ester polyols, such as, for example, the reaction products of polyether polyols with poly (carbomethoxy-substituted) diphenyls and/or benzyl esters, or the reaction products of glycols (especially glycols of formula (2)) with polyethylene terephthalate.

The other polyol or polyols (hereinafter, collectively, the “second hydroxyl-containing polyol”) employable in a polyol blend composition for use in the practice of this invention can be any hydroxyl containing polyol (other than a formula (1) polyol) having the properties desired in a given case. Preferably, such other polyol has a number average molecular weight ranging from about 60 to about 6000, a hydroxyl value of from about 18 to about 1870, and a functionality of from 2 to 4, inclusive. Aliphatic polyols are preferred, including diols, triols, and tetrols. Examples of suitable classes of second hydroxyl-containing polyols include:

(a) polyalkoxylated Mannich bases prepared by reacting phenols with diethanol amine and formaldehyde;

(b) polyalkoxylated glycerines;

(c) polyalkoxylated sucrose;

(d) polyalkoxylated aromatic and aliphatic amine based polyols;

(e) polyalkoxylated sucrose-amine mixtures;

(f) hydroxyalkylated aliphatic monoamines and/or diamines;

(g) aliphatic polyols (including alkylene diols, cycloalkylene diols, alkoxyalkylene diols, polyether polyols, and halogenated polyether polyols);

(h) polybutadiene resins having primary hydroxyl groups;

(i) phosphorous containing polyols; and the like.

Illustrative, but non-limiting, examples of suitable particular polyols for use as the second hydroxyl-containing polyol include ethylene glycol, diethylene glycol, 1,3-propanediol, 1,4-butanediol, and other butylene glycols, glycerine, dipropylene glycol, trimethylene glycol, 1,1,1-trimethylol propane, pentaerythritol, 1,2,6-hexanetriol, 1,1,1-trimethylolethane, 3-(2-hydroxyethoxy)-1,2- propane diol, 1,2-cyclohexanediol, triethylene glycol, tetraethylene glycol, and higher glycols, or mixtures thereof (with molecular weights falling within the range above indicated), ethoxylated glycerine, ethoxylated trimethylol propane, ethoxylated pentaerythritol, and the like, polyethylene succinate, polyethylene glutarate, polyethylene adipate, polybutylene succinate, polybutylene glutarate, polybutylene adipate, copolyethylenebutylene succinate, copolyethylenebutylene glutarate, copolyethylenebutylene adipate, and the like hydroxyl terminated polyesters, bis(beta-hydroxyethyl) terephthalate, bis(beta-hydroxyethyl) phthalate, and the like, di(polyoxyethylene) succinate, polyoxydiethylene glutarate, polyoxydiethylene adipate, polyoxydiethylene adipate glutarate, and the like hydroxyl terminated polyesters; diethanolamine, triethanolamine, N,N′-bis(beta-hydroxyethyl) aniline, and the like, sorbitol, sucrose, lactose, glycosides, such as alpha-methylglucoside and alpha-hydroxyalkyl glucoside, fructoside, and the like; compounds in which hydroxyl groups are bonded to an aromatic nucleus, such as resorcinol, pyrogallol, phloroglucinol, di-, tri-, and tetraphenylol compounds, such as bis-(p-hydroxyphenyl)-methane and 2,2-bis-(p-hydroxyphenyl)propane, cocoamides, alkylene oxide adducts of Mannich type products prepared by reacting phenols, diethanolamine and formaldehyde, and many other such polyhydroxyl compounds known to the art.

Preferred second hydroxyl group-containing polyols are alkylene and/or lower alkoxyalkylene diols, such as diethylene glycol or propylene glycol, mixtures thereof, hydroxyl terminated polyesters, and the like, which each have a molecular weight of from about 69 to 4000. By the term “lower” as used herein, reference is had to a radical containing less than eight carbon atoms.

The most preferred second hydroxyl group-containing polyols are polycaprolactone, polyethylene adipate glycol, polyethylenebutylene adipate glycol, polybutylene adipate glycol, polyethylenepropylene adipate glycol, polytetramethylene glycol, ethylene oxide capped polypropylene glycol, and poly 1,6 hexane adipate glycol.

In a preferred embodiment, the ratio of weight percent of the first hydroxyl group-containing polyol to the weight percent of the second hydroxyl group-containing polyol is in the range of from about 1:99 to about 99:1, more preferably from about 80:20 to about 20:80, and most preferably about 50:50.

The polyols described above are reacted with diisocyanate monomers to form polyurethane prepolymers. The diisocyanate monomers are most typically TDI or MDI. MDI is commercially available as the pure 4,4′-diphenyl methane diisocyanate isomer (e.g., Mondur MP, Bayer) and as a mixture of isomers (e.g., Mondur ML, Bayer and Lupranate MI, BASF). As employed herein, “MDI” means all isomeric forms of diphenyl methane diisocyanate. The most preferred form is the pure 4,4′-isomer. Other aromatic diisocyanate monomers that can be used in the practice of the present invention include PPDI, 3,3′-dimethyl-4,4′-biphenyl diisocyanate (TODI), naphthalene-1,5-diisocyanate (NDI), diphenyl-4,4′-diisocyanate, stilbene-4,4′-diisocyanate, benzophenone-4,4′-diisocyanate, and mixtures thereof Aliphatic diisocyanate monomers include dibenzyl-4,4′-diisocyanate, isophorone diisocyanate (IPDI), 1,3 and 1,4-xylene diisocyanates, 1,6-hexamethylene diisocyanate, 1,3-cyclohexyl diisocyanate, 1,4-cyclohexyl diisocyanate (CHDI), the three geometric isomers of 1,1′-methylene-bis(4-isocyanatocyclohexane) (H₁₂MDI), and mixtures thereof

The stoichiometric ratio of isocyanato groups to hydroxyl groups in the reactants should preferably be from about 1.3/1 to about 4/1. When the ratio is much lower, the molecular weight of the isocyanato terminated polyurethane becomes so large that the viscosity of the mass makes mixing of chain extenders into the prepolymer relatively more difficult. At the other extreme, a ratio of two isocyanato groups to one hydroxyl group is the theoretical ratio for the end-capping of an ester polyol with a diisocyanate. Ratios near or in excess of 2/1 will result in high levels of free diisocyanate in the mixture. Therefore, where it is desired to avoid or minimize free diisocyanate, the preferred range is 1.4/1 to 1.6/1.

Alternatively, a mole ratio in the range from about 2:1 to about 20:1, preferably 5:1 to 10:1, diisocyanate/polyol can be used in the practice of the present invention. Here, reaction temperatures ranging from about 30° C. to about 120° C. are practical. Maintaining the reaction temperature at a temperature in the range of from about 50° C. to about 110° C. with agitation is preferred.

The crude reaction product prepared in this manner normally contains a large amount of unreacted diisocyanate and solvent, which can be removed by distillation. Any distillation equipment that can be efficiently operated at deep vacuum, moderate temperature, and short residence time can be used in this step. For example, one can use an agitated film distillation system commercialized by Pope Scientific, Inc.; Artisan Industries, Inc.; GEA Canzler GmbH & Co.; Pfaudler-U.S., Inc.; InCon Technologies, L.L.C.; Luwa Corp.; UIC Inc.; or Buss-SMS GmbH for this purpose. Continuous units with internal condensers are preferred because they can reach lower operating vacuums of 0.001 to 1 torr.

It is practical to strip excess diisocyanate and solvent, if present, at a pressure around 0.04 Torr and at a temperature between about 120° C. and about 175° C., although stripping at 0.02 torr or below and 140° C. or below may generate the best results.

The importance of minimizing high temperature degradation of prepolymers from aromatic diisocyanate monomers is described in U.K. Patent No. 1,101,410, which recommends that distillation be conducted under vacuum with an evaporative temperature, preferably under 175° C. U.S. Pat. No. 4,182,825 describes the use of evaporative jacket temperatures of 150-160° C. for TDI prepolymers. U.S. Pat. No. 5,703,193 recommends a jacket temperature of 120° C.

As a rule of thumb, it is desirable in the operation of agitated film distillation equipment that the condenser temperature for the distillate be at least about 100° C. below the evaporative temperature. This provides a driving force for the rapid and efficient evaporation, then condensation, of the distillate. Thus, for example, to distill off MDI monomer at an evaporator temperature of 140° C. or lower (to avoid thermal decomposition of the prepolymer), a condenser temperature of 40° C. or below is desirable. Since neat MDI has a melting point of about 40° C., a higher condenser temperature is required to prevent solidification of the MDI in the condenser. The use of a solvent permits condensation at lower temperatures, e.g., 30° C. or lower. Thus, the use of a solvent makes possible the use of lower evaporator temperatures for avoiding thermal decomposition of the prepolymer.

If the recommended stripping conditions are observed, the residue (prepolymer) can contain less than 0.1% solvent and about 0.1 to about 0.3% MDI after one pass, and the distillate can come out clean and remain transparent at room temperature. The distillate can then be reused to produce more prepolymer.

For curing these prepolymers, the number of —NH₂ groups in the aromatic diamine component should be approximately equal to the number of —NCO groups in the prepolymer. In general, from about 80 to 110% of the stoichiometric equivalent should be used, preferably about 85 to 100%.

The reactivity of isocyanato groups with amino groups varies according to the structure to which the groups are attached. As is well known, as for example in U.S. Pat. No. 2,620,516, some amines react very rapidly with some isocyanates, while others react more slowly. In the latter case, catalysts may be used to cause the reaction to proceed fast enough to make the product non-sticky within 30-180 seconds. For some of the aromatic diamines, the temperature of the reaction or of the polyurethane reactant will only need to be controlled in order to obtain the proper reaction time. Thus, for a diamine that ordinarily would be too reactive, a catalyst would obviously be unnecessary, and a lowering of the reaction temperature would suffice. A great variety of catalysts is available commercially for accelerating the reaction of the isocyanato groups with compounds containing active hydrogen atoms (as determined by the well-known Zerewitinoff test). It is well within the skill of the technician in this field to pick and choose catalysts to fit his particular needs or desires and adjust the amounts used to further refine his conditions. Adipic acid and triethylene diamine (available under the trademark Dabco™) are typical of suitable catalysts.

Generally, the prepolymers obtained as described above can have low viscosities, low monomeric diisocyanate levels, and NCO contents of from about 2 to about 25%. The prepolymers can be easily chain-extended by various chain extenders at moderate processing temperatures. The chain extenders can, for example, be water, aliphatic diols, aromatic diamines, or their mixtures.

Representative preferred chain extenders include aliphatic diols, such as, 1,4-butanediol (BDO), di(beta-hydroxyethyl) ether (HER), di(beta-hydroxypropyl) ether (HPR), hydroquinone-bis-hydroxyethyl ether (HQEE), 1,3-propanediol, ethylene glycol, 1,6-hexanediol, and 1,4-cyclohexane dimethanol (CHDM); aliphatic triols and tetrols, such as, trimethylol propane; adducts of propylene oxide, and/or ethylene oxide having molecular weights in the range of from about 190 to about 500, such as, various grades of Voranol (Dow Chemical), Pluracol (BASF Corp.) and Quadrol (BASF Corp.); and polyester polyols based upon esters of phthalic anhydride.

Preferred diamine chain extenders include 4,4′-methylene-bis(3-chloroaniline) (MBCA), 4,4′-methylene-bis(3-chloro-2,6-diethylaniline (MCDEA), diethyl toluene diamine (DETDA, Ethacure™ 100 from Albemarle Corporation), tertiary butyl toluene diamine (TBTDA), dimethylthio-toluene diamine (Ethacure™ 300 from Albemarle Corporation), trimethylene glycol di-p-amino-benzoate (Vibracure® A157 from Uniroyal Chemical Company, Inc. or Versalink 740M from Air Products and Chemicals), methylenedianiline (MDA) and methylenedianiline-sodium chloride complex (Caytur® 21 and 31 from Uniroyal Chemical Company, Inc.).

The most preferred chain extenders are BDO, HQEE, MBCA, Vibracure A157, MCDEA, Ethacure 300, and DETDA.

Polyurethane elastomers can be made by extending the chains of the prepolymers with the above chain extenders by methods known in the art. The amine or diol chain extender and the prepolymer are mixed together to polymerize. The chain extension temperature will typically be within the range of about 20° C. to about 150° C.

For industrial casting operations, a working life (pour life) of at least sixty seconds is typically required to mix the prepolymer and the chain extender and to pour the mixture into molds without bubbles. In many cases, a working life of 5 to 10 minutes is preferred. For purposes of the present invention, “working life” (or “pour life”) means the time required for the mixture of prepolymer and chain extender to reach a Brookfield viscometer viscosity of 200 poise when each component is “preheated” to a temperature at which the viscosity is 15 poise or lower, preferably, 10 poise or lower.

The present invention resides in the recognition of the superior performance provided by this specific polyester urethane chemistry. Polyurethane articles of manufacture, made preferably via castable urethane technology, are the intended primary utility of these described prepolymers and cured elastomers. These articles have a body made of the elastomer of this invention and may take the form of any article conventionally made of polyurethane or other elastomers or rubbers, such as a belt, hose, air spring, shoe sole, shoe heel, small or large elastomeric-containing wheel assemblies (i.e. skate wheels, industrial tires, automotive-type elastomers and tires). Any article needing improved dynamic flex life (improved flex fatigue resistance) can benefit from the elastomers of this invention, which, in a preferred embodiment can provide a flex fatigue resistance of at least about 32,000 cycles to break and up to about 3,000,000 cycles to break (Texus Flex test: angle of deflection —35°; strain—30%.)

One end use of this chemistry is a tire that is non-pneumatic in character, but that can perform on the highway with durability and vehicle handling characteristics similar to a pneumatic tire. The non-pneumatic tire described in U.S. Pat. No. 4,934,425, the disclosure of which is hereby incorporated by reference, would be an example of this use of the prepolymer and polyurethane elastomer materials of the instant invention. This embodiment encompasses a non-pneumatic tire rotatable about an axis, having improved hysteresis and flex fatigue resistance comprising: an annular body of the resilient polyester urethane elastomeric materials of the present invention cured with an aromatic diamine curative. In a further specialized embodiment, these elastomers are used to make the annular body of the device of U.S. Pat. No. 4,934,425, which discloses a tire structure having an annular body having a generally cylindrical outer member at the outer periphery thereof, a generally cylindrical inner member spaced radially inward from and coaxial with said outer member, a plurality of axially extending, circumferentially spaced-apart rib members connected at their corresponding inner and outer ends to said inner and outer cylindrical members, said rib members being generally inclined at an angle of about 0° to 75° to radial planes which intersect them at their inner ends, and at least one web member having opposite side faces, said web member having its inner and outer peripheries connected respectively to said inner and outer cylindrical members, said web member being connected on at least one of its side faces to at least one of said rib members to thereby form with said rib member a load-carrying structure for said outer cylindrical member, said load carrying structure being constructed to permit locally loaded members to buckle.

The advantages and the important features of the present invention will be more apparent from the following examples.

### EXAMPLE 1

This example demonstrates that the incorporation of diethylene glycol phthalic anhydride based polyester polyol in a urethane prepolymer provides unexpected enhancement of several properties. Although the supplier of o-phthalic anhydride ester polyols (Stepan Company, e.g., Stepan PS4002 and Stepan PH56), has disclosed the following advantages to urethanes from inclusion of PS4002: low viscosity, excellent hydrolysis resistance, hardness/flexibility balance, clarity, and adhesion promotion, it has now been found unexpectedly that other properties are enhanced by incorporation of even a very low level of this type of polyol by comparing compositions with and without this type of polyol cured by the same curative to the same Shore A hardness. These enhanced properties are reduced thermoplasticity, significantly increased tear strength - both when measured at ambient temperature and at elevated temperature (70° C.), significantly higher flex fatigue resistance, and higher tensile strength and % elongation at the same Hardness. These enhancements are realized with very little sacrifice of good dynamic properties, which can be very useful in the application of urethanes. The data supporting these conclusions are given in the tables below.

In Table 2, the physical property data are given for the two compositions described in Table 1 below, which differ in the types of ingredients only by the presence or absence of the polyol named Stepan PS4002. Stepan PS4002 is described by the supplier, Stepan Company, as a polyol of about 400 molecular weight from diethylene glycol and phthalic anhydride. Its structural formula is understood to be:

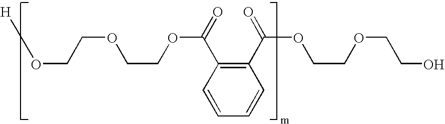

Both urethane prepolymers were cured by 1,4 butanediol under the same conditions of temperature and with the same procedure. The enhancement of properties can be readily seen in these data.

TABLE 1

| Prepolymer Ingredients | Experimental | | Control | |
|---|---|---|---|---|
| MDI | 342.60 | grams | 303.18 | grams |
| Polybutylene adipate glycol | 571.40 | grams | 571.40 | grams |
| Trimethylol propane | 1.84 | grams | 1.84 | grams |
| Stepan P84002¹ | 18.00 | grams | 0 | grams |
| Percent NCO | 8.90 | grams | 8.60 | grams |

¹o-Phthalic Anhydride polyester polyol, approximately 280 molecular weight.

The process used to make the prepolymers is as follows:

1. A reactor that is clean and dry is provided with a nitrogen blanket and connected to a source of vacuum.

2. The diisocyanate is charged to the reactor with either vacuum or under a nitrogen blanket.

3. Polyols and any glycol are added still under a nitrogen blanket or with negative pressure of vacuum and agitation.

4. Stirring is maintained and the temperature held in the range of from about 70 to about 110° C., preferably 70-90° C. with a ±5° C. variation allowed for at least 2 hours and as many as 8 hours. Again, either a nitrogen blanket or a vacuum is maintained for the total reaction time.

5. The product is then passed through a filter and packaged with a nitrogen flush before capping.

TABLE 2
Part A

| | Control | | Experimental | |
|---|---|---|---|---|
| Processing: | | | | |
| Viscosity at 212° F. | 7 | | 6.4 | |
| Pot Life (t to 100 P) | 4.5 | minutes | 1 | minute |
| Physical Properties:* | | | | |
| Shore A Hardness | 93 | | 93 | |
| Modulus at 100% E | 1543 | | 1610 | |
| Modulus at 200% E | 2406 | | 2487 | |
| Modulus at 300% E | 4237 | | 4350 | |
| Tensile Strength, psi | 5377 | | 8240 | |
| Percent Elongation | 330 | | 430 | |
| Tear C, RT | 540 | | 603 | |
| Split Tear, RT | 153 | | 170 | |
| Trouser Tear, RT | 243 | | 447 | |
| Tear C, 70° C. | 337 | | 427 | |
| Split Tear, 70° C. | 62 | | 81 | |
| Trouser Tear, 70° C. | 78 | | 113 | |
| Compression Set B | 29 | | 43 | |
| Bashore Rebound | 43 | | 37 | |
| Compressive Moduli | | | | |
| 5% | 380 | | 387 | |
| 10% | 747 | | 768 | |
| 15% | 1096 | | 1134 | |
| 20% | 1464 | | 1528 | |
| 25% | 1880 | | 1986 | |

TABLE 2
Part B

| | Control | Experimental |
|---|---|---|
| Texus Flex: | | |
| Cycles to 50% Cut Growth | | |
| 30% Strain, 30°< | 7000 | 19000 |
| 45% Strain, 45°< | <5000 | <5000 |
| Cycles to Break | | |
| 30% Strain, 30°< | 9500 | 32000 |
| 45% Strain, 45°< | <5000 | 11000 |
| Rheometrics | | |
| Temp at 50° C. | | |
| G′ | 1.91E+08 | 1.78E+08 |
| Tan | 0.0616 | 0.0761 |
| Temp at 70° C. | | |
| G′ | 1.63E+08 | 1.37E+08 |
| Tan | 0.0443 | 0.058 |
| Temp at 130° C. | | |
| G′ | 1.14E+08 | 9.93E+07 |
| Tan | 0.0221 | 0.0271 |
| Critical Temperature (° C.) | 140 | 140 |
| R.T. Modulus | 2.23E+08 | 2022E+08 |
| R.T. Tan | 0.0824 | 0.0974 |
| Tc Modulus | 1.10E+08 | 9.51E+07 |
| Tc Tan | 0.0216 | 0.027 |
| Modulus Ratio Tc/RT | 0.49 | 0.43 |
| Tg (Max of Tan) − ° C. | −20.5 | −19.9 |
| G′ at Tg | 1.01E+09 | 1.57E+09 |
| Tan at Tg | 0.3388 | 0.3157 |
| Thermoplasticity: Shore A vs Temperature | | |
| 158° F. | 85 | 88 |
| 212° F. | 82 | 87 |
| 240° F. | 80 | 85 |

*Cure Conditions: Resin 200° F., 1,4 Butanediol at 97% theory and at R.T.

### EXAMPLE 2

This example is directed to the use of hexanediol-o-phthalic anhydride polyester polyol in the polyurethane elastomers of the present invention. Stepan PH56, a 2000 molecular weight polyol, was used as an example of this class. The structural formula of Stepan PH56 is understood to be:

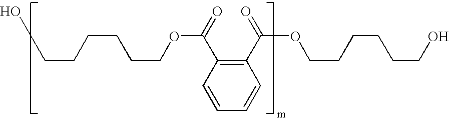

It was reacted with MDI (4,4 diphenyl methane) by itself and in a 50/50 ratio with other commercial polyols. The other polyols were polycaprolactone, polyethylene adipate glycol, polyethylenebutylene adipate glycol, polybutylene adipate glycol, and polyethylenepropylene adipate glycol.

### Properties vs Adipate Esters and Polycaprolactone Esters

Evaluation of the above mentioned adipate polyester and polycaprolactone blends with Stepan PH56 show an unexpected balance of properties for polyurethane types of polymers. Certain properties have not been simply averaged for the blends. Property comparisons are given in Tables 3-A through 3-F. In particular, prepolymer from Stepan PH56 as the sole polyol and the prepolymers from Stepan PH56/polyester diol blends displayed exceptionally high flexural strength as measured by Texus flex. The Texus flex values for the blends were not diminished from of the prepolymer based on the Stepan PH56 alone. The test was done with a cut initiated and therefore predicts very high resistance to cut growth. This is further supported by higher split tear where the Stepan polyol was used alone and in blends with the esters. Further, other stress-strain and compression set properties remain acceptable. Control prepolymers that were MDI/adipate polyester or MDI/polycaprolactone polyester alone were used for the evaluation.

Another property enhanced by having the Stepan PH56 present in the blends is hydrolytic stability in water at 212° F. and in water at 80° C. The urethane made from the Stepan polyol alone is exceptionally good for a polyester type. The prepolymers that are blends of Stepan and adipate type esters are much more resistant than prepolymers based on the adipate esters alone. The properties measured here after aging are tensile, modulus and elongation.

The exceptional flex fatigue resistance, tear and hydrolytic stability in the blends above occur while good mechanical properties and compression set are retained.

The stability of the prepolymers that have blends of the Stepan ester and adipate ester is very good in 50% NaOH in water up to at least 28 days.

Properties that are not as good with Stepan PH56 present are rebound and low temperature flexibility.

The above prepolymers were made directly by adding the two polyols to MDI and reacting them together. It is probable that if prepolymers containing the respective polyols separately were physically blended, the same result would be obtained. The prepolymers were prepared as described above.

In Tables 3-A through 3-F, the following abbreviations and other designations have been used:

PCLT=polycaprolactone

Initiator: refers to small molecule diols used to initiate growth in the manufacture of the polycaprolactones.

PBAG=polybutyleneadipate glycol

PTMG=polytetramethylene glycol

PEBAG=polyethylenebutyleneadipate glycol

PEAG=polyethyleneadipate glycol

PEPAG=polyethylenepropyleneadipate glycol

PAPEPolyol=o-phthalic anhydride polyester polyol

Cure Condition A: Resin 200° F., 1,4 Bd 97% TH., RT, PC16hrs @ 240° F.

Cure Condition B: Resin 180° F., 1,4 Bd 97% TH., RT, PC16hrs @ 240° F.

TABLE 3 - A
Processing Physical Properties of Various Polyurethane Elastomers

| Prepolymer Designation | RQ25-90 | RQ25-91 | RQ25-92 |
|---|---|---|---|
| Polyol Type (2000 MW) | PCLT | PCLT | PCLT |
| Initiator (for polycaprolactones) | Bd | NPG | 1,6 Hexane |
| Cure Conditions | A | A | A |
| Unaged Prepolymer Processing | | | |
| Properties | | | |
| Viscosity at 212° F. (Poise) | 7 | 4.7 | 4.7 |
| Pot Life (t to 100 Poise) | 5′50″ | 4′42″ | 6′05″ |
| Physical Properties | | | |
| % NCO | 6.8 | 7 | 7.25 |
| Shore A Final Hardness - 4 days | 85 | 85 | 86 |
| Shore A Final Hardness - 8 weeks | 85-6 | 87 | 87 |
| Modulus @ 100% Elongation | 850 | 887 | 850 |
| Modulus at 300% Elongation | 2090 | 1927 | 1843 |
| Tensile Strength, psi | 6983 | 7033 | 6873 |
| % Elongation | 443 | 460 | 490 |
| Compression Set B, % | 27 | 59 | 47 |
| Bashore Rebound, % | 45 | 45 | 47 |
| Tear C, ppi | 478 | 487 | 467 |
| Split Tear, ppi | 100 | 97 | 87 |
| Trouser Tear, ppi | 120 | 98 | 150 |
| Compressive Moduli | | | |
| 5% | 180 | 213 | 209 |
| 10% | 352 | 414 | 402 |
| 15% | 532 | 613 | 596 |
| 20% | 729 | 821 | 803 |
| 25% | 951 | 1051 | 1040 |
| Flex Life (Texus Flex) | | | |
| Strain = 30% | 10,000 | 15,000 | 20,000 |
| Strain = 45% | 7,500 | 7,500 | 17,250 |
| (ASTM Method D3629-78, 70° C., | | | |
| backward direction) | | | |
| Rheometrics Dynamics | | | |
| Spectrometer, Rectangular | | | |
| Torsion Mode | | | |
| At 50° C. | | | |
| G′ | 7.97E+07 | 1.03E+08 | 8.89E+07 |
| Tan | 0.0182 | 0.0253 | 0.0278 |
| At 70° C. | | | |
| G′ | 6.89E+07 | 8.89E+07 | 7.24E+07 |
| Tan | 0.0128 | 0.0194 | 0.0219 |
| At 130° C. | | | |
| G′ | 5.76E+07 | 6.79E+07 | 6.02E+07 |
| Tan | 0.0112 | 0.0174 | 0.021 |
| Brittle Point (° C.) | <−72 | <−72 | <−72 |
| Vol. Swell % 80/20 | | | |
| Oil/Diesel Fuel | 5.29 | 6.59 | 6.21 |
| Hydrolytic Stability | | | |
| Aged 1 Week in water @ 212° F. | | | |
| Modulus at 100% Elongation | 463 | 560 | 583 |
| % Ret | 54.5 | 63.1 | 68.5 |
| Modulus at 300% Elongation | 1030 | 1170 | 1260 |
| % Ret | 49.3 | 60.7 | 68.3 |
| Tensile Strength, psi | 2777 | 3750 | 4063 |
| % Ret | 39.8 | 53.3 | 59.1 |
| % Elongation | 690 | 703 | 643 |
| % Ret | 156 | 153 | 131 |
| Aged 2 Weeks in water @ 80° C. | | | |
| Modulus at 100% Elongation | 610 | 804 | 761 |
| % Ret | 71.8 | 90.6 | 89.5 |
| Modulus at 300% Elongation | 1566 | 1798 | 1774 |
| % Ret | 74.9 | 93.3 | 96.3 |
| Tensile Strength, psi | 5420 | 5777 | 4942 |
| % Ret | 77.6 | 82.1 | 71.9 |
| % Elongation | 542 | 535 | 501 |
| % Ret | 122 | 116 | 102 |
| Aged 4 Weeks in water @ 80° C. | | | |
| Modulus at 100% Elongation | 613 | 681 | 647 |
| % Ret | 72.1 | 76.8 | 76.1 |
| Modulus at 300% Elongation | 1026 | 1094 | 1198 |
| % Ret | 49.1 | 56.8 | 65 |
| Tensile Strength, psi | 1521 | 1787 | 3103 |
| % Ret | 21.8 | 25.4 | 45.1 |
| % Elongation | 569 | 674 | 703 |
| % Ret | 128 | 147 | 143 |
| Aged 6 Weeks in water @ 80° C. | | | |
| Tensile Strength, psi | 66.5 | 366 | 428 |
| % Ret | 0.95 | 5.2 | 6.2 |
| % Elongation | 1.98 | 28 | 40 |
| % Ret | 0.45 | 6.09 | 8.2 |

TABLE 3 - B
Processing Physical Properties of Various Polyurethane Elastomers

| Prepolymer Designation | RQ25-93 | FF6-145 | FF6-148 |
|---|---|---|---|
| Polyol (2000 MW) | PBAG/ | PBAG | PCLT |
| Initiator | PTMG250 @ | | DEG |
| | 30% | | |
| Cure Conditions | A | B | B |
| Unaged Prepolymer | | | |
| Processing | | | |
| Properties | | | |
| Viscosity at 212° F. (Poise) | 7.8 | 10 | 5.4 |
| Pot Life (t to 100 Poise) | 4′22″ | 8′ | 6′10″ |
| Physical Properties | | | |
| % NCO | 7.07 | 6.1 | 6.81 |
| Shore A Final Hardness - | 90 | 87 | 86 |
| 4 days | | | |
| Shore A Final Hardness - | 90 | 87-8 | 87 |
| 8 weeks | | | |
| Modulus @ 100% Elongation | 1070 | 1080 | 1050 |
| Modulus at 300% Elongation | 1880 | 2380 | 2090 |
| Tensile Strength, psi | 5820 | 7707 | 6573 |
| % Elongation | 493 | 497 | 640 |
| Compression Set B, % | 26 | 30 | 21 |
| Bashore Rebound, % | 50 | 45 | 45 |
| Tear C, ppi | 542 | 512 | 491 |
| Split Tear, ppi | 109 | 103 | 83 |
| Trouser Tear, ppi | 140 | 190 | 95 |
| Compressive Moduli | | | |
| 5% | 263 | 218 | 205 |
| 10% | 99 | 418 | 400 |
| 15% | 723 | 66 | 595 |
| 20% | 965 | 831 | 99 |
| 25% | 1247 | 1074 | 1029 |
| Flex Life (Texus Flex) | | | |
| Strain = 30% | 30,000 | 12,500 | 7,500 |
| Strain = 45% | 20,000 | 7,500 | 5,000 |
| (ASTM Method D3629-78, | | | |
| 70° C., | | | |
| backward direction) | | | |
| Rheometrics Dynamics | | | |
| Spectrometer, Rectangular | | | |
| Torsion Mode | | | |
| At 50° C. | | | |
| G′ | 1.53E+08 | 9.70E+07 | 1.02E+08 |
| Tan | 0.0329 | 0.0399 | 0.0368 |
| At 70° C. | | | |
| G′ | 1.40E+08 | 8.80E+07 | 9.53E+07 |
| Tan | 0.0275 | 0.0319 | 0.027 |
| At 130° C. | | | |
| Brittle Point (° C.) | −72.60 | <−72 | <−72 |
| Hydrolytic Stability | | | |
| Aged 1 Week in water @ | | | |
| 212° F. | | | |
| Modulus at 100% Elongation | 700 | 753 | 570 |
| % Ret | 65.4 | 69.7 | 54.3 |
| Modulus at 300% Elongation | 1323 | 0 | 1217 |
| % Ret | 70.4 | 0 | 58.2 |
| Tensile Strength, psi | 4467 | 762 | 1860 |
| % Ret | 76.8 | 9.9 | 58.7 |
| % Elongation | 687 | 127 | 655 |
| % Ret | 139 | 25.5 | 102 |
| Aged 2 Weeks in water @ | | | |
| 80° C. | | | |
| Modulus at 100% Elongation | 926 | 776 | 769 |
| % Ret | 86.5 | 71.9 | 73.2 |
| Modulus at 300% Elongation | 1624 | 1366 | 1666 |
| % Ret | 86.4 | 57.4 | 79.7 |
| Tensile Strength, psi | 3397 | 2814 | 4707 |
| % Ret | 58.4 | 36.5 | 71.6 |
| % Elongation | 498 | 624 | 490 |
| % Ret | 101 | 126 | 76.6 |
| Aged 4 Weeks in water @ | | | |
| 80° C. | | | |
| Modulus at 100% Elongation | 763 | Sample | 613 |
| % Ret | 71.3 | Broke | 58.4 |
| Modulus at 300% Elongation | 1236 | | 1131 |
| % Ret | 65.7 | 0 | 54.1 |
| Tensile Strength, psi | 3681 | | 2127 |
| % Ret | 63.2 | 0 | 32.4 |
| % Elongation | 732 | | 624 |
| % Ret | 148 | 0 | 98 |
| Aged 6 Weeks in water @ | | | |
| 80° C. | | | |
| Tensile Strength, psi | 612 | | 735 |
| % Ret | 10.52 | | 11.2 |
| % Elongation | 70 | | 18.8 |
| % Ret | 14.2 | | 2.9 |

TABLE 3 - C
Processing Physical Properties of Various Polyurethane Elastomers

| Prepolymer | VIBRATHANE | VIBRATHANE | |
|---|---|---|---|
| Designation | 8520 | 8523 | FF6-160B |
| Polyol Type | PEBAG | PEAG | PEPAG |
| (2000 MW) | | | |
| Cure Conditions | B | B | B |
| Unaged Prepolymer | | | |
| Processing Properties | | | |
| Viscosity at 212° F. | 7.5 | 8 | 6 |
| Pot Life | 7′ | 6′ | 10′36″ |
| (t to 100 Poise) | | | |
| Physical Properties | | | |
| % NCO | 7.49 | 7.27 | 6.38 |
| Shore A Final | 90 | 89 | 87 |
| Hardness - 8 weeks | | | |
| Modulus @ 100% | 1140 | 1120 | 917 |
| Elongation | | | |
| Modulus @ 300% | 2010 | 2260 | 1834 |
| Elongation | | | |
| Tensile Strength, psi | 7283 | 6440 | 7126 |
| % Elongation | 540 | 590 | 627 |
| Compression Set B, % | 67 | 29 | 43 |
| Bashore Rebound, % | 40 | 36 | 34 |
| Tear C, ppi | 554 | 649 | 502 |
| Split Tear, ppi | 101 | 133 | 130 |
| Trouser Tear, ppi | 133 | 290 | 351 |
| Compressive Moduli | | | |
| 5% | 254 | 239 | 211 |
| 10% | 463 | 444 | 391 |
| 15% | 662 | 647 | 570 |
| 20% | 878 | 871 | 759 |
| 25% | 1137 | 1137 | 981 |
| Flex Life (Texus Flex) | | | |
| Strain = 30% | 10,000 | 80,000 | 30,000 |
| Strain = 45% | 10,000 | 70,000 | |
| (ASTM Method | | | |
| D3629-78, 70° C., | | | |
| backward direction) | | | |
| Rheometrics Dynamics | | | |
| Spectrometer, | | | |
| Rectangular | | | |
| Torsion Mode | | | |
| At 50° C. | | | |
| G′ | 1.06E+08 | 1.23E+08 | 7.21E+07 |
| Tan | 0.0442 | 0.043 | 0.0482 |
| At 70° C. | | | |
| G′ | 8.75E+07 | 1.00E+08 | 6.10E+07 |
| Tan | 0.0343 | 0.0339 | 0.0385 |
| At 130° C. | | | |
| G′ | 7.05E+07 | 7.65E+07 | 3.88E+07 |
| Tan | 0.0267 | 0.0393 | 0.0587 |
| Brittle Point (° C.) | −70.6 | −39.8 | −36.8 |
| Hydrolytic Stability | | | |
| Aged 1 Week in | | | |
| water @ 212° F. | | | |
| Modulus at 100% | Samples | Samples | Samples |
| Elongation | | | |
| % Ret | Broke | Broke | Broke |
| Aged 2 Weeks in | | | |
| water @ 80° C. | | | |
| Modulus at 100% | 670 | 0 | Too Soft |
| Elongation | | | |
| % Ret | 58.8 | 0 | |
| Modulus at 300% | 0 | 0 | |
| Elongation | | | |
| % Ret | 0 | 0 | |
| Tensile Strength, psi | 759 | 0 | |
| % Ret | 104 | 0 | |
| % Elongation | 148 | 0 | |
| % Ret | 27.4 | 0 | |
| Aged 4 Weeks in | | | |
| water @ 80° C. | | | |
| Modulus at 100% | Samples | Samples | Samples |
| Elongation | | | |
| % Ret | Broke | Broke | Broke |

TABLE 3 - D
Processing Physical Properties of Various Polyurethane Elastomers

| Prepolymer | VIBRATHANE | VIBRATHANE | |
|---|---|---|---|
| Designation | 8585 | 8590 | RQ25-116 |
| Polyol Type | PEAG | PEAG | Stepan |
| (2000 MW) | | | PH56 |
| Cure Conditions | B | B | B |
| Unaged Prepolymer | | | |
| Processing Properties | | | |
| Viscosity at 212° F. | 7 | 5 | 14.7 |
| Pot Life | 6.7′ | 4.5′ | 3′ |
| (t to 100 Poise) | | | |
| Physical Properties | | | |
| % NCO | 6.78 | 8.07 | 5.97 |
| Shore A Final | 86 | 91 | 97A, |
| Hardness - 4 days | | | 60D |
| Shore A Final | 86 | | |
| Hardness - 8 weeks | | | |
| Modulus at 100% | 978 | 1169 | 1677 |
| Elongation | | | |
| Modulus at 300% | 2233 | 2856 | 3111 |
| Elongation | | | |
| Tensile Strength, psi | 7210 | 7263 | 3560 |
| % Elongation | 519 | 486 | 366 |
| Compression Set B, % | 51 | 26 | 54 |
| Bashore Rebound, % | 30 | 30 | 37 |
| Tear C, ppi | 535 | 611 | 596 |
| Split Tear, ppi | 108 | 117-138 | 136 |
| Trouser Tear, ppi | 215 | | |
| Compressive Moduli | | | |
| 5% | 187 | 273 | 557 |
| 10% | 351 | 526 | 1060 |
| 15% | 520 | 776 | 1544 |
| 20% | 706 | 1038 | 2063 |
| 25% | 926 | 1328 | 2647 |
| Flex Life (Texus Flex) | | | |
| Strain = 30% | 45,000 | | 520,000 |
| (ASTM Method | | | |
| D3629-78, 70° C., | | | |
| backward direction) | | | |
| Rheometrics Dynamics | | | |
| Spectrometer, | | | |
| Rectangular | | | |
| Torsion Mode | | | |
| At 50° C. | | | |
| G′ | 7.25E+07 | 1.11E+08 | 8.08E+07 |
| Tan | 0.048 | 0.0583 | 0.3648 |
| At 70° C. | | | |
| G′ | 5.765E+07 | 9.67E+07 | 5.01E+07 |
| Tan | 0.0349 | 0.0389 | 0.1314 |
| At 130° C. | | | |
| G′ | 4.73E+07 | 7.13E+08 | 2.78E+07 |
| Tan | 0.0219 | 0.0231 | 01301 |
| Brittle Point (° C.) | −54.8 | | |
| Hydrolytic Stability | | | |
| Aged 1 Week in | | | |
| water @ 212° F. | | | |
| Modulus at 100% | Samples | | 1240 |
| Elongation | | | |
| % Ret | Broke | | 74 |
| Modulus at 300% | | | 2580 |
| Elongation | | | |
| % Ret | | | 86 |
| Tensile Strength, psi | | | 3073 |
| % Ret | | | 86 |
| % Elongation | | | 377 |
| % Ret | | | 103 |
| Aged 3 Weeks in | | | |
| water @ 212° F. | | | |
| Modulus at 100% | | | 1144 |
| Elongation | | | |
| % Ret | | | 68 |
| Modulus at 300% | | | 2405 |
| Elongation | | | |
| % Ret | | | 77 |
| Tensile Strength, psi | | | 3025 |
| % Ret | | | 85 |
| % Elongation | | | 403 |
| % Ret | | | 110 |
| Aged 2 Weeks in | | | |
| water @ 80° C. | | | |
| Modulus at 100% | 0 | | 1141 |
| Elongation | | | |
| % Ret | 0 | | 68 |
| Modulus at 300% | 0 | | 2655 |
| Elongation | | | |
| % Ret | 0 | | 85 |
| Tensile Strength, psi | 343 | | 3312 |
| % Ret | | | 93 |
| % Elongation | 48 | | 373 |
| % Ret | | | 102 |
| Aged 4 Weeks in | | | |
| water @ 80° C. | | | |
| Modulus at 100% | Sample | Sample | 1022 |
| Elongation | | | |
| % Ret | Broke | Broke | 61 |
| Modulus at 300% | | | 2251 |
| Elongation | | | |
| % Ret | | | 72 |
| Tensile Strength, psi | | | 3102 |
| % Ret | | | 87 |
| % Elongation | | | 2447 |
| % Ret | | | 669 |
| Aged 6 Weeks in | | | |
| water @ 80° C. | | | |
| Modulus at 100% | | | 1323 |
| Elongation | | | |
| % Ret | | | 79 |
| Modulus at 300% | | | 2650 |
| Elongation | | | |
| % Ret | | | 85 |
| Tensile Strength, psi | | | 3427 |
| % Ret | | | 96 |
| % Elongation | | | 393 |
| % Ret | | | 107 |

TABLE 3 - E
Processing Physical Properties of Various Polyurethane Elastomers

| Prepolymer Designation | FF7-12B | FF7-13 | FF7-13A |
|---|---|---|---|
| Polyol Type (2000 MW) | PAPEPolyol | PAPEPolyol | PAPEPolyol |
| | | PCLT | PCLT |
| | | 50/50 | 50/50 |
| Cure Conditions | B | B | B |
| Unaged Prepolymer | | | |
| Processing Properties | | | |
| Viscosity at 212° F. | 89 | 10.7 | 10.7 |
| Pot Life (t to 100 Poise) | flowable | 4′55″ | 4′07″ |
| | at 11′ | | |
| Physical Properties | | | |
| % NCO | 3.11 | 5.39 | 5.33 |
| Shore A Final Hardness - | 88 drift to | 79 | 80 |
| 8 weeks | 65, 12 day | | |
| Modulus at 100% | 507 | 707 | 717 |
| Elongation | | | |
| Modulus at 300% | 947 | 1283 | 1350 |
| Elongation | | | |
| Tensile Strength, psi | 2967 | 4700 | 5807 |
| % Elongation | 543 | 527 | 537 |
| Compression Set B, % | 86 | 43 | 46 |
| Bashore Rebound, % | 19 | 12 | 12 |
| Tear C, ppi | 257 | 390 | 387 |
| Split Tear, ppi | 64 | 98 | 105 |
| Trouser Tear, ppi | 207 | 217 | 220 |
| Compressive Moduli | | | |
| 5% | 189 | 141 | 140 |
| 10% | 315 | 278 | 271 |
| 15% | 444 | 422 | 412 |
| 20% | 596 | 581 | 567 |
| 25% | 777 | 763 | 745 |
| Flex Life (Texus Flex) | | | |
| Strain = 30% | 2,953,218 | >2,953,215 | >2,953,215 |
| Strain = 45% | >2,158,880 | >2,158,880 | >2,158,880 |
| (ASTM Method D3629-78, | | | |
| 70° C., | | | |
| backward direction) | | | |
| Rheometrics Dynamics | | | |
| Spectrometer, Rectangular | | | |
| Torsion Mode | | | |
| At 50° C. | | | |
| G′ | 1.81E+07 | 4.59E+07 | 5.25E+07 |
| Tan | 0.4568 | 0.0622 | 0.0555 |
| At 70° C. | | | |
| G′ | 1.13E+07 | 3.29E+07 | 3.96E+07 |
| Tan | 0.1786 | 0.0547 | 0.0474 |
| At 130° C. | | | |
| G′ | Severe loss | 1.68E+07 | 2.29E+07 |
| Tan | in modulus | 0.1019 | 0.0906 |

TABLE 3 - F
Processing Physical Properties of Various Polyurethane Elastomers

| Prepolymer | RQ125- | RQ125- | RQ125- | RQ125- |
|---|---|---|---|---|
| Designation | 120B | 120C | 120D | 120E |
| Polyol Type | PAPEPolyol | PAPEPolyol | PAPEPolyol | PAPEPolyol |
| (2000 MW) | PEBAG | PEAG | PBAG | PEPAG |
| | 200 | 2000 | 2000 | 2000 |
| | 50/50 | 50/50 | 50/50 | 50/50 |
| Cure | B | B | B | B |
| Conditions | | | | |
| Unaged | | | | |
| Prepolymer | | | | |
| Processing | | | | |
| Properties | | | | |
| Pot Life (t to | 5′10″ | 4′50″ | 5′14″ | 6′40″ |
| 100 Poise) | | | | |
| Physical | | | | |
| Properties | | | | |
| % NCO | 7.05 | 7.03 | 6.7 | 6.98 |
| Shore A Final | 89 dr 86 | 88 | 88 | 88 dr 85 |
| Hardness - | | | | |
| 8 weeks | | | | |
| Modulus @ | 1144 | 1075 | 1223 | 1169 |
| 100% | | | | |
| Elongation | | | | |
| Modulus @ | 2271 | 2111 | 2652 | 2269 |
| 300% | | | | |
| Elongation | | | | |
| Tensile | 3918 | 5788 | 4175 | 3219 |
| Strength, psi | | | | |
| % Elongation | 445 | 584 | 397 | 402 |
| Compression | 30 | 25 | 29 | 43 |
| Set B, % | | | | |
| Bashore | 20 | 14 | 19 | 14 |
| Rebound, % | | | | |
| Tear C, ppi | 485 | 504 | 463 | 433 |
| Split Tear, ppi | 116 | 584 | 121 | 119 |
| Trouser Tear, | 259 | 381 | 258 | 295 |
| ppi | | | | |
| Compressive | | | | |
| Moduli | | | | |
| 5% | 228 | 212 | 257 | 225 |
| 10% | 449 | 425 | 500 | 447 |
| 15% | 676 | 645 | 739 | 676 |
| 20% | 920 | 881 | 994 | 930 |
| 25% | 1198 | 1148 | 1298 | 1229 |
| Flex Life | | | | |
| (Texus Flex) | | | | |
| Strain = 30% | 2,421,000 | 2,421,000 | 1,224,000 | 2,421,000 |
| Strain = 45% | 1,600,000 | 1,600,000 | 657,000 | 1,600,000 |
| (ASTM | | | | |
| Method | | | | |
| D3629-78, | | | | |
| 70° C., | | | | |
| backward | | | | |
| direction) | | | | |
| Rheometrics | | | | |
| Dynamics | | | | |
| Spectrometer, | | | | |
| Rectangular | | | | |
| Torsion Mode | | | | |
| At 50° C. | | | | |
| G′ | 8.18E+07 | 7.83E+07 | 1.04E+08 | 7.94E+07 |
| Tan | 0.0953 | 0.0995 | 0.0777 | 0.1135 |
| At 70° C. | | | | |
| G′ | 6.10E+07 | 6.09E+07 | 8.55E+07 | 5.57E+07 |
| Tan | 0.0629 | 0.0648 | 0.0507 | 0.0808 |
| At 130° C. | | | | |
| G′ | 4.02E+07 | 4.56E+07 | 5.36E+07 | 3.24E+07 |
| Tan | 0.0703 | 0.047 | 0.045 | 0.1131 |
| Hydrolytic | | | | |
| Stability | | | | |
| Aged 1 Week | | | | |
| in water @ | | | | |
| 212° F. | | | | |
| Modulus at | 449 | | 541 | |
| 100% | | | | |
| Elongation | | | | |
| % Ret | 39.2 | | 44.2 | |
| Modulus at | | | 760 | |
| 300% | | | | |
| Elongation | | | | |
| % Ret | | | 28.7 | |
| Tensile | 455 | 385 | 767 | 366 |
| Strength, psi | | | | |
| % Ret | 11.6 | 6.7 | 18.4 | 11.4 |
| % Elongation | 82 | 46 | 359 | 70 |
| % Ret | 18.4 | 7.9 | 90.4 | 17.4 |
| Hydrolytic | | | | |
| Stability | | | | |
| Aged 3 Weeks | | | | |
| in water @ | | | | |
| 212° F. | | | | |
| Tensile | 750 | 561 | 287 | 720 |
| Strength, psi | | | | |
| % Ret | 66 | 52 | 23.5 | 60.6 |
| % Elongation | 19 | 2 | 8 | 11 |
| Aged 2 Weeks | | | | |
| in water @ | | | | |
| 80° C. | | | | |
| Modulus at | 625 | 690 | 657 | 670 |
| 100% | | | | |
| Elongation | | | | |
| % Ret | 54.6 | 64.2 | 53.7 | 57.3 |
| Modulus at | 1165 | 1207 | 1593 | 1075 |
| 300% | | | | |
| Elongation | | | | |
| % Ret | 51.3 | 57.2 | 60.1 | 47.4 |
| Tensile | 2220 | 2393 | 3673 | 1203 |
| Strength, psi | | | | |
| % Ret | 56.7 | 41.3 | 88 | 37.4 |
| % Elongation | 570 | 560 | 487 | 360 |
| % Ret | 78 | 96.9 | 123 | 89.6 |
| Aged 6 Weeks | | | | |
| in water @ | | | | |
| 80° C. | | | | |
| Tensile | 310 | 360 | 418 | 347 |
| Strength, psi | | | | |
| % Elongation | 28 | 25 | 50 | 31 |

Examples 3-9 below utilize the diisocyanate toluene diisocyanate (TDI).

Example 3 contains the DEG (diethylene glycol) based o-phthalate polyester polyol, and example 5 the 1.6 hexane diol based o-phthalate polyester polyol. Unexpectedly, urethane based on the former (DEG based) displays significant improvement in flex life without compromising percent rebound and the diminution of dynamics, as expressed by the rheometrics, is much less.

Examples 7, 8, and 9 describe the synthesis and physical property evaluation of an ether-type polyol ethylene oxide capped polypropylene glycol with and without the o-phthalate 1,6 hexane polyester polyol. TDI is used as the diisocyanate.

Examples 10, 11, and 12 have the same polyols, but MDI is the diisocyanate. Improvement in flex life is again seen with some sacrifice of rebound and dynamics.

Example 13 describes the synthesis of a prepolymer from a 50/50 mixture of 2000 MW o-phthalate 1,6 hexane diol polyester polyol and poly1,6 hexaneadipatediol reacted with MDI.

Example 14 describes the synthesis of a control prepolymer without the phthalate type prepolymer.

Example 15 shows the advantage in flex life realized by using the product of Example 13 in a urethane elastomer.

Examples 16, 17, and 18 describe the synthesis and physical property evaluation of systems containing another ether type polyol, polytetramethyleneglycol (PTMG), with the o-phthalate 1,6 hexanediol polyester polyol. MDI is the diisocyanate used in these prepolymers. Improvement in flex life is again seen, with some sacrifice of rebound and dynamics.

### EXAMPLE 3

A urethane prepolymer composition was made by reacting a 50/50 weight % mixture of 1 kg of a 2000 MW o-phthalate/diethylene glycol based polyester polyol (Agent 2229-34 from Stepan Chemical Co.) and 1 kg of polyethyleneadipateglycol (PEAG) of 2000 MW with 376 grams of TDI.

The two polyols were added to a 3-neck round bottom flask fitted with a stirrer and a thermometer, followed by the TDI and the application of heat from a Thermo-Watch controlled heating mantle. The reaction temperature was maintained at 80° C. for two hours and then the product was vacuum degassed.

The resulting product was determined to have excess NCO of 4.3%.

### EXAMPLE 4

A urethane prepolymer composition was made by reacting a one kg. of a 2000 MW PEAG with 188.6 grams of TDI. This serves as a control for comparing the physical properties of the cured urethane with that of Example 3.

The procedure followed was the same as example one except that only one polyol was charged. The final percent NCO was 3.91.

### EXAMPLE 5

A urethane prepolymer composition was made by reacting a 50/50 weight % mixture of 1500 grams of a 2000 MW o-phthalate/1,6 hexanediol-based polyester polyol (PH56 from Stepan Chemical Co.) and 1500 grams of a 2000 MW PEAG with 577 grams of TDI following the procedure of Example 3. This serves as a control for comparing physical properties of the cured urethane with that of Examples 3 and 4. The final percent NCO was 4.09.

### EXAMPLE 6

The three different prepolymer compositions from Examples 3 through 5 above were all chain extended with 4,4′-methylene-bis(3-chloroaniline) (MOCA) at 95% of theory to form elastomers. The physical properties of the resultant elastomers were evaluated and are provide in Table 4. The flex life improvement for the two o-phthalate based systems compared with the all PEAG polyol system is very significant although the DEG type is less than the 1,6 hexane diol type. Surprisingly, the dynamic properties and % rebound of the DEG based o-phthalate system were not changed much vs. the control elastomer (Example 3). The dynamics and % rebound are compromised in the case of 1,6 hexanediol based system.

TABLE 4

| Example | 3 | 4 | 5 |
|---|---|---|---|
| Flex life relative to control (Example 4). | | | |
| Cycles to failure. | | | |
| 35% Strain | 1.9X | X | 4X |
| 45% Strain | 4.2X | X | 28X |
| Shore A Hardness | 86 | 87 | 89 |
| % Rebound (In-house drop ball test) | 33 | 34 | 25 |
| Rheometrics: | | | |
| T_{g} (max. tan δ) | −22° C. | <22° C. | 8° C. |
| Critical Temperature (C.T.)¹ | 180° C. | 127° C. | 137° C. |
| Tan δ at C.T. | 0.0352 | 0.0226 | 0.0324 |
| Tan δ at 50° C.² | 0.0875 | 0.0570 | 0.1302 |
| Tan δ at 70° C. | 0.0664 | 0.0412 | 0.0788 |
| Tan δ at 130° C. | 0.0355 | 0.0221 | 0.0331 |

¹With increasing temperature, tan δ falls to a plateau, then increases again. This = C.T.
²The lower values are correlated with better dynamic behaviour.

### EXAMPLE 7

A urethane prepolymer composition was made by reacting a 25/75 weight % mixture of 500 grams of a 2000 MW o-phthalate/1,6 hexane diol based polyester polyol (Stepan PH56) and 1500 grams of a 2000 MW ethylene oxide capped polypropylene glycol (EOPPG) with 354 grams of TDI following the procedure of Example 3. The final percent NCO was 3.43.

### EXAMPLE 8

A urethane prepolymer composition was made by reacting tw kg. of 2000 MW ethylene oxide capped polypropylene glycol (EOPPG) with 353 grams of TDI following the procedure of Example 3. This served as a control to determine the effect of the ortho-phthalate/1,6 hexane diol based polyester polyol on the properties. The final percent NCO was 3.35.

### EXAMPLE 9

The prepolymer compositions from Examples 7 and 8 were chain extended with MOCA at 95% of theory to form elastomers. The physical properties of the resultant elastomers were evaluated. These properties are given in Table 5. The flex life improvement for the o-phthalate 1,6 hexane based systems compared with the all EOPPG polyol system is very significant. Tan δ from rheometrics is very similar for both urethanes at elevated temperatures although the T_{g} as indicated by Tan δ is higher for the PH56-containing system. Bashore rebound is lower for the latter.

TABLE 5

| Example | 7 | 8 (Control) |
|---|---|---|
| Flex life relative to control. | | |
| (Cycles to failure) | | |
| 35% Strain | 4X | X |
| 45% Strain | 3.2X | 1.04X |
| Shore A Hardness | 77 | 71 |
| % Rebound (In-house drop ball test) | 31 | 45 |
| Rheometrics: | | |
| T_{g} (max tan δ) | −13° C. | −32° C. |
| Critical Temperature (C.T.) | 177+° C. | 177+° C. |
| Tan δ at C.T. | 0.0504 | 0.0610 |
| Tan δ at 50° C.¹ | 0.0618 | 0.064 |
| Tan δ at 70° C.¹ | 0.0484 | 0.0553 |
| Tan δ at 130° C.¹ | 0.0317 | 0.0383 |

¹The lower values are correlated with better dynamic behaviour.

### EXAMPLE 10

A urethane prepolymer composition was made by reacting a 25/75 weight % mixture 500 grams of a 2000 MW o-phthalate/1,6 hexane diol based polyester polyol (Stepan PH56) and 1500 grams of a 2000 MW EOPPG with 750 grams of MDI following the procedure of Example 3. The final percent NCO was 5.98.

### EXAMPLE 11

A urethane prepolymer composition was made by reacting two kg. of a 2000 MW EOPPG with 750 grams of MDI following the procedure given in Example 3. This served as a control to determine the effect of the o-phthalate/1,6 hexane diol based polyester polyol on the properties. The final percent NCO was 5.74.

### EXAMPLE 12

The prepolymer compositions from examples 10 and 11 were chain extended with 1,4-butanediol at 97% of theory to form elastomers. The physical properties of the resultant elastomers were evaluated. These properties are given in Table 6. The flex life improvement for the o-phthalate 1,6 hexane based systems compared with the all EOPPG polyol system is very significant. Tan δ from rheometrics is very similar for both urethanes at elevated temperatures although the T_{g} as indicated by tan δ is higher for the PH56-containing system. Bashore rebound is lower for the latter.

TABLE 6

| Example | 10 | 11 (Control) |
|---|---|---|
| Flex life relative to control. | | |
| (Cycles to failure) | | |
| 35% Strain | 25X | X |
| 45% Strain | 25x | 1.5X |
| Shore A Hardness | 77 | 71 |
| % Rebound (In-house drop ball test) | 41 | 56 |
| Rheometrics: | | |
| T_{g} (max tan δ) | −11° C. | −22° C. |
| Critical Temperature (C.T.) | 147° C. | 147° C. |
| Tan δ at C.T. | 0.0965 | 0.0805 |
| Tan δ at 50° C.¹ | 0.0517 | 0.0435 |
| Tan δ at 70° C.¹ | 0.0499 | 0.0454 |
| Tan δ at 130° C.¹ | 0.0807 | 0.0805 |

¹The lower values are correlated with better dynamic behaviour.

### EXAMPLE 13

A urethane prepolymer composition was made by reacting a 25/75 weight % of a mixture of 500 grams of a 2000 MW o-phthalate/1,6 hexanediol based polyester polyol (PH56 from Stepan Chemical Co.) and 1500 grams of a 2000 MW poly1,6-hexaneadipate glycol (PHAG) with 776 grams of MDI following the procedure given in Example 3. The final percent NCO was 6.30.

### EXAMPLE 14

A urethane prepolymer composition was made by reacting 1500 grams of a 2000 MW PHAG with 536 grams of MDI following the procedure of Example 3. This prepolymer was made to serve as a control for evaluation of the prepolymer of Example 13. The final percent NCO was 6.68.

### EXAMPLE 15

The prepolymers of examples 13 and 14 were chain extended with 1,4 butanediol at 97% of theory to form an elastomer. The physical properties of the resultant elastomer were evaluated and compared. These properties are given in Table 7. As seen below, the o-phthalate/1,6 hexane diol based urethane provided very significant improvement in flex life without compromising rebound.

TABLE 7

| Example | 13 | 14 (Control) |
|---|---|---|
| Flex life (Texus Flex) | | |
| (Cycles to failure) | | |
| 35% Strain | 495,000 | 264,000 |
| 45% Strain | | 185,000 |
| Shore A Hardness | 85 | 96 |
| % Rebound (In-house drop ball test) | 38 | 41 |
| Rheometrics: | | |
| T_{g} (max tan δ) | −21° C. | −1.4° C. |
| Critical Temperature (C.T.) | 70° C. | 138° C. |
| Tan δ at C.T. | 0.0913 | 0.0554 |
| Tan δ at 50° C.¹ | 0.0745 | 0.0656 |
| Tan δ at 70° C.¹ | 0.0913 | 0.0509 |
| Tan δ at 130° C.¹ | 0.2035 | 0.0532 |

¹The lower values are correlated with better dynamic behaviour.

### EXAMPLE 16

A urethane prepolymer composition was made by reacting a 50/50 weight % mixture of one kg. of a 2000 MW o-phthalate/1,6 hexane diol based polyester polyol (Stepan PH56) and one kg. of a 1000 MW polytetramethylene glycol (PTMG) with 701 grams of MDI following the procedure given in Example 3. The final percent NCO was 7.64.

### EXAMPLE 17

A urethane prepolymer composition was made by reacting 50/50 wt ratio of one kg. of a 1000 MW PTMG and one kg. of a 2000 MW PTMG with 701 grams of MDI following the procedure of Example 3. This served as a control to determine the effect of the o-phthalate/1,6 hexane diol based polyester polyol on the properties. The final percent NCO was 7.69.

### EXAMPLE 18

The prepolymer compositions from examples 16 and 17 were chain extended with 1,4-butanediol at 97% of theory to form an elastomer. The physical properties of the resultant elastomer were evaluated. These properties are given in Table 8. The flex life improvement for the o-phthalate,1,6 hexane based systems compared with the all PTMG polyol system is significant. Tan δ from rheometrics is higher at elevated temperature (detrimental for dynamic properties), T_{g} is higher, and Bashore rebound is lower.

TABLE 8

| Example | 16 | 17 (Control) |
|---|---|---|
| Flex life relative to control. | | |
| (Cycles to failure) | | |
| 35% Strain | 1.7X | X |
| 45% Strain | 1.11X | 0.5X |
| Shore A Hardness | 91 | 90 |
| % Rebound (In-house drop ball test) | 23 | 57 |
| Rheometrics: | | |
| T_{g} (max tan δ) | 8° C. | −40° C. |
| Critical Temperature (C.T.) | 130° C. | 130° C. |
| Tan δ at C.T. | 0.0387 | 0.0204 |
| Tan δ at 50° C.¹ | 0.0710 | 0.0294 |
| Tan δ at 70° C.¹ | 0.0505 | 0.0225 |
| Tan δ at 130° C.¹ | 0.0387 | 0.0204 |

¹The lower values are correlated with better dynamic behaviour.

In view of the many changes and modifications that can be made without departing from principles underlying the invention, reference should be made to the appended claims for an understanding of the scope of the protection to be afforded the invention.

What is claimed is:

1. A polyurethane elastomer comprising:
the acellular reaction product of a prepolymer comprising:
the reaction product of:
1) an aromatic ester polyol having the structure: 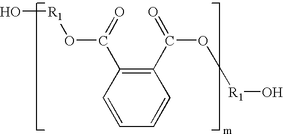
wherein:
R₁ is a divalent radical selected from the group consisting of:
(a) alkylene radicals of from 2 to 6 carbon atoms, and
(b) radicals of the formula:
—(R₂O)ₙ—R₂—
wherein R₂ is an alkylene radical of 2 or 3 carbon atoms, n is an integer of from 1 to 3, and m is an integer of from 1 to 15; and
2) a diisocyanate;
with a chain extender selected from the group consisting of water, aliphatic diols, aromatic diamines, and mixtures thereof.

2. The elastomer of claim 1 wherein R₁ is an alkylene radical of from 2 to 6 carbon atoms.

3. The elastomer of claim 2 wherein R₁ is hexylene.

4. The elastomer of claim 1 wherein R₁ is a radical of the formula:
—(R₂O)ₙ—R₂—
wherein R₂ is an alkylene radical of 2 or 3 carbon atoms and n is an integer of from 1 to 3.

5. The elastomer of claim 4 wherein R₁ is diethyl ether.

6. The elastomer of claim 4 wherein R₁ is diethylene glycol.

7. The elastomer of claim 1 wherein the diisocyanate is MDI or TDI.

8. The elastomer of claim 1 wherein the chain extender is an aromatic diamine.

9. The elastomer of claim 8 wherein the aromatic diamine is selected from the group consisting of 4,4′-methylene-bis(3-chloroaniline); 4,4′-methylene-bis(3-chloro-2,6-diethylaniline; diethyl toluene diamine; tertiary butyl toluene diamine; dimethylthio-toluene diamine; trimethylene glycol di-p-amino-benzoate; methylenedianiline; and methylenedianiline-sodium chloride complex.

10. The elastomer of claim 1 wherein the polyurethane elastomer has a flex fatigue resistance of at least about 32,000 cycles to break.

11. A polyurethane elastomer comprising:
the acellular reaction product of a prepolymer comprising:
the reaction product of:
1) an aromatic ester polyol having the structure: 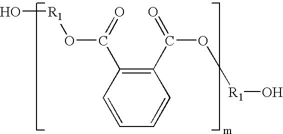
wherein:
R₁ is a divalent radical selected from the group consisting of:
(a) alkylene radicals of from 2 to 6 carbon atoms, and
(b) radicals of the formula:
—(R₂O)ₙ—R₂—
wherein R₂ is an alkylene radical of 2 or 3 carbon atoms, n is an integer of from 1 to 3, and m is an integer of from 1 to 15; and
2) a second hydroxyl-containing polyol different from said first hydroxyl-containing ester polyol; with
3) at least one diisocyanate;
with a chain extender selected from the group consisting of water, aliphatic diols, aromatic diamines, and mixtures thereof.

12. The elastomer of claim 11 wherein R₁ is an alkylene radical of from 2 to 6 carbon atoms.

13. The elastomer of claim 12 wherein R₁ is hexylene.

14. The elastomer of claim 11 wherein R₁ is a radical of the formula:
—(R₂O)ₙ—R₂—
wherein R₂ is an alkylene radical of 2 or 3 carbon atoms and n is an integer of from 1 to 3.

15. The elastomer of claim 14 wherein R₁ is diethyl ether.

16. The elastomer of claim 14 wherein R₁ is diethylene glycol.

17. The elastomer of claim 11 wherein the diisocyanate is MDI or TDI.

18. The elastomer of claim 11 wherein the chain extender is an aromatic diamine.

19. The elastomer of claim 18 wherein the aromatic diamine is selected from the group consisting of 4,4′-methylene-bis(3-chloroaniline); 4,4′-methylene-bis(3-chloro-2,6-diethylaniline; diethyl toluene diamine; tertiary butyl toluene diamine; dimethylthio-toluene diamine; trimethylene glycol di-p-amino-benzoate; methylenedianiline; and methylenedianiline-sodium chloride complex.

20. The elastomer of claim 11 wherein the second hydroxy-containing polyol is selected from the group consisting of:
(a) polyalkoxylated Mannich bases prepared by reacting phenols with diethanol amine and formaldehyde;
(b) polyalkoxylated glycerines;
(c) polyalkoxylated sucrose;
(d) polyalkoxylated aromatic and aliphatic amine based polyols;
(e) polyalkoxylated sucrose-amine mixtures;
(f) hydroxyalkylated aliphatic monoamines or diamines or mixtures thereof;
(g) aliphatic polyols selected from the group consisting of alkylene diols, cycloalkylene diols, alkoxyalkylene diols, polyether polyols, and halogenated polyether polyols;
(h) polybutadiene resins having primary hydroxyl groups; and
(i) phosphorous containing polyols.

21. The elastomer of claim 11 wherein the second hydroxy-containing polyol is selected from the group consisting of polycaprolactone, polyethylene adipate glycol, polyethylenebutylene adipate glycol, polybutylene adipate glycol, polyethylenepropylene adipate glycol, polytetramethylene glycol, ethylene oxide capped polypropylene glycol, and poly 1,6 hexane adipate glycol.

22. The elastomer of claim 11 wherein the polyurethane elastomer has a flex fatigue resistance of at least about 32,000 cycles to break.
